(19) United States
(12) Patent Application Publication
(10) Pub. No.: US 2005/0147103 A1
(43) Pub. Date: Jul. 7, 2005

(54) Packet scheduling method and apparatus

(75) Inventors: Zong Kai Yang, Wu Han City (CN); Yan Liu, Wu Han City (CN); YuMing Wang, Wu Han City (CN); Bing Fan, Wu Han City (CN)

Correspondence Address: SUGHRUE MION, PLLC, 2100 PENNSYLVANIA AVENUE, N.W., SUITE 800, WASHINGTON, DC, 20037, US

(73) Assignees: SAMSUNG ELECTRONICS CO., LTD.; HUAZHONG UNIVERSITY OF SCIENCE & TECHNOLOGY

(21) Appl. No.: 10/822,145

(22) Filed: Apr. 12, 2004

(30) Foreign Application Priority Data
Apr. 11, 2003 (CN) 03118918.0
Mar. 23, 2004 (KR) 2004-19627

(51) Int. Cl. H04L 12/56

(52) U.S. Cl. 370/395.4

(57) ABSTRACT

A packet scheduling method and apparatus including (a) classifying a stream that enters into a scheduler according to a data rate and/or length of a packet; (b) if the packet of the classified stream is a first packet, storing the packet in a first stream queue, and if the packet of the classified stream is a subsequent packet, storing the packet in a second stream queue; (c) counting a virtual start service time of the packet stored in the first stream queue according to a weighted fairness queuing method; and (d) counting a virtual start service time of the packet stored in the second stream queue as a virtual start service time of the previous packet.

### BACKGROUND OF THE INVENTION

This application claims priority from Chinese Patent Application No. 03118918.0, filed on Apr. 11, 2003, in the Chinese Intellectual Property Office and Korean Patent Application No. 2004-19627, filed on Mar. 23, 2004, in the Korean Intellectual Property Office, the disclosures of which are incorporated herein in their entirety by reference.

1. Field of the Invention

The present invention relates to a network communication system and applications thereof, and more particularly, to a packet scheduling method that can be especially applied to packet scheduling in a router.

2. Description of the Related Art

The development of the Internet has lead to considerable advancements in the multimedia industry. Generally, bandwidth and delay are two factors that largely affect audio and video multimedia applications. As such, a router requires effective and fast packet scheduling to provide reliable quality of service (QoS) to network devices.

In order to perform the function of QoS, a scheduling algorithm based on a generalized processor sharing (GPS) model, such as WFQ, WF²Q, or WF²Q⁺ has been widely used. The GPS model is an ideal stream model based on the following assumptions: (1) the length of a packet can be unlimitedly divided; and (2) all the streams can accept the service at the same time. Since in a practical system, the minimum unit that a scheduler serves is a packet and the scheduler serves only one stream at one time, it cannot be realized by the GPS model. Jon C. R. Bennett and Hui Zhang (J. Bennett and H. Zhang, “Hierarchical Packet Fair Queuing Algorithms”, Proceedings of the ACM-SIGCOMM96, pages 143-156, Palo Alto, Calif., August 1996) have developed a WF²Q scheduling algorithm to simulate the GPS model in a practical system. The basic idea of the algorithm is to maintain a start service time and a finish service time for each packet in the stream. Before the scheduler transmits a packet, it needs to carry out the quality test for the packet which is to be scheduled. Only packets whose start service time is shorter than a system virtual time can pass the test, and the packet with the minimum finish service time in the packets which have passed the test will be sent. This strategy is called the smallest eligible virtual finish time first (SEFF) selection strategy.

Because the WF²Q⁺ algorithm has good fairness and delay properties and is not extremely complicated, it has been broadly used in the field. However, there are some practical problems when applying it: first, the complexity of the algorithm is increased with the increase of the stream to be scheduled, in particular, in the case of a high-speed core router, if the quantity of a data stream is large, the application of the algorithm will cause much load on the system, and second, it is not easy to realize the hardware to perform the algorithm.

### SUMMARY OF THE INVENTION

The present invention provides a packet scheduling method and apparatus, which are simple and effective and guarantee the performance of a WF²Q⁺ algorithm for quality of service (QoS).

According to an aspect of the present invention, there is provided a packet scheduling method. The packet scheduling method divides scheduled packets into a first stream queue and a second stream queue and stores the packets in the first and second stream queues, and then, performs scheduling on each packet by a smallest eligible virtual finish time first (SEFF) strategy. The procedures are as follows:

(1) A scheduling node is initialized, and an initial value of a system virtual time is set.

(2) If a predetermined packet reaches the scheduling node, it is checked whether the packet is a first packet of a data stream. If the packet is the first packet of the data stream, the packet is stored at an end of a first stream queue Q1 according to a data rate and/or length of a corresponding data stream, and a virtual start service time is counted by Equation 2. The time is a virtual start service time of the data stream. If the packet is not the first packet of the data stream, the packet is directly stored at the end of the data stream.

(3) In scheduling, a scheduler scans the virtual start service time for a head packet of a first data stream in all the queues. After that, a legal packet whose virtual start service time is shorter than the system virtual time is detected, and a virtual finish service time of the legal packet is counted by Equation 4. After that, the packet is transmitted at a minimum virtual finish service time.

(4) The procedures of transmitting the selected head packet are as follows: first, a packet is extracted from a corresponding data stream and transmitted. After that, the packet of the data stream is stored at an end of a backlog stream queue Q₂(Rₓ, L_{y}) according to the data rate and length of a new head packet. After that, the virtual start service time of the data stream is renewed by Equation 3 (described later). This time is also a virtual start service time of a new head packet of the data stream. After that, the system virtual time is renewed by Equation 1 (described later).

(5) The above-described procedures (2) through (4) are repeatedly performed until scheduling is terminated.

The packet scheduling method comprises (a) classifying a stream according to a data rate and/or length of a packet; (b) if the packet of the classified stream is a first packet, storing the packet in a first stream queue, and if the packet of the classified stream is a subsequent packet, storing the packet in a second stream queue; (c) counting a virtual start service time of the packet stored in the first stream queue according to a weighted fairness queuing method; and (d) counting a virtual start service time of the packet stored in the second stream queue as a virtual start service time of the previous packet.

Step (c) is performed in accordance with the following equation;
Sᵢ^{k}=max(V(aᵢ^{k}),Fᵢ^{k-1})(where Qᵢ=0),
where Sᵢ^{k} is a virtual start service time of a k-th packet of an i-th stream, V(t) is a system virtual time function, aᵢ^{k} is an arrival time of the k-th packet of the i-th stream, Fᵢ^{k-1} is a virtual finish service time of a (k−1)-th packet of the i-th stream, and Qᵢ is the quantity of the previous packet contained in a corresponding queue of the i-th stream.

The method further comprises (e) detecting a legal packet whose virtual start service time is shorter than a system virtual service time by scanning the virtual start service time of the packets stored in the first stream queue and the second stream queue.

According to another aspect of the present invention, there is provided a packet scheduling apparatus. The packet scheduling apparatus comprises a classifier, which classifies a stream according to a data rate and/or length of a packet; a first stream queue in which a first packet of the classified stream is stored; a second stream queue in which a subsequent packet of the classified stream is stored; and a SEFF selector, which detects a legal packet from all the packets stored in the first stream queue and the second stream queue according to a SEFF strategy.

### BRIEF DESCRIPTION OF THE DRAWINGS

The above aspects and advantages of the present invention will become more apparent by describing in detail exemplary embodiments thereof with reference to the attached drawings in which:

FIG. 1 schematically shows a packet scheduling method according to the present invention;

FIG. 2 shows an internal structure of first and second stream queues according to an embodiment of the present invention;

FIG. 3 is a time flowchart showing a packet scheduling method according to an embodiment of the present invention;

FIG. 4 is a time flowchart showing a system virtual service time is renewed between transmission of a previous packet and transmission of a next packet;

FIG. 5 shows a structure of first and second stream queues according to another embodiment of the present invention;

FIG. 6 shows a simulation topological structure according to the present Invention;

FIG. 7 shows the bandwidth of a data stream according to the embodiment shown in FIG. 2;

FIG. 8 shows the bandwidth jitter of the data stream according to the embodiment shown in FIG. 2;

FIG. 9 shows the delay of the data stream according to the embodiment shown in FIG. 2;

FIG. 10 shows the delay jitter of a data stream according to the embodiment shown in FIG. 2;

FIG. 11 shows the bandwidth of a data stream according to the embodiment shown in FIG. 5;

FIG. 12 shows the bandwidth jitter of the data stream according to the embodiment shown in FIG. 5;

FIG. 13 shows the delay of the data stream according to the embodiment shown in FIG. 5; and

FIG. 14 shows the delay jitter of a data stream according to the embodiment shown in FIG. 5.

### DETAILED DESCRIPTION OF THE INVENTION

Hereinafter, exemplary embodiments of the present invention will be described in detail with reference to the accompanying drawings.

First, equations and symbols that will be used in the following descriptions are defined using Equations 1 through 4 and Table 1.
V(t+τ)=max(V(t)+τ, min_{iεB(t)}Sᵢ^{hi(t)}) (1)
Sᵢ^{k}=max(V(aᵢ^{k}),Fᵢ^{k-1})(where Qᵢ=0) (2)
Sᵢ^{k}=Fᵢ^{k-1} (where Qᵢ≠0) (3)

$${F}_{i}^{k} = {S}_{i}^{k} + \frac{{L}_{i}^{k}}{{R}_{i} ( t )} \qquad ( 4 )$$

TABLE 1

| | |
|---|---|
| V(t) | Virtual time function of system |
| Sᵢ^{k} | Virtual start service time of packet k of data stream i |
| Fᵢ^{k} | Virtual finish service time of packet k of data stream i |
| τ | Renewal time-interval of system virtual time |
| B(t) | Set of all the streams to be backlogged in system at time t |
| Hi(t) | Serial number of head packet of data stream i at time t |
| Qi | Quantity of packet to be scheduled in data stream i |
| aᵢ^{k} | Arrival time of packet k of data stream i |
| Lᵢ^{k} | Length of packet k of data stream i |
| Rᵢ (t) | Data rate of data stream i at time t |

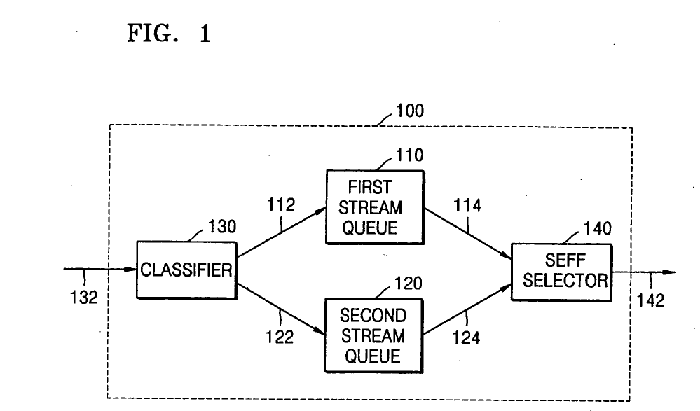

FIG. 1 shows a structure of a scheduler for explaining a packet scheduling method according to an embodiment of the present invention.

A scheduler 100 comprises a classifier 130, a first stream queue 110, a second stream queue 120, and a SEFF selector 140.

A virtual time function V(t) of the scheduler 100 is given by Equation 1.
V(t+τ)=max(V(t)+τ, min_{iεB(t)}Sᵢ^{hi(t)} (1)

V(t) is a virtual time function of the scheduler 100, τ is a time-interval of system virtual time renewal, B(t) is the assembly of all the streams to be backlogged in the scheduler 100, hi(t) is a serial number of a head packet of a data stream i, and Sᵢ^{k} is a virtual start service time of a k-th packet.

The classifier 130 classifies data streams according to a data rate. A quantification grade is M, which is sequentially marked as R₁, R₂, . . . , and Rₘ. Likewise, packets of the data streams are classified according to lengths by a quantification grade N, which is sequentially marked as L₁, L₂, . . . , and Lₙ. For different data streams, the grade of length quantification may be the same or not as that of other data streams. Various data queues are obtained by a combination of R and L, and each of the data queues is represented as Q(Rₘ, Lₙ). As such, M×N data queues are obtained, and a packet 132 which enters into the scheduler 100 is classified according to the rate of a stream to which the packet belongs and the length of the packet and stored in different queues.

For a predetermined data rate (R=Rₘ) and the length L (Lₙ₋₁<L<Lₙ) of a head packet, each data stream is stored in a corresponding queue Q(Rₘ, Lₙ). The head packet is stored at presently first positions of the first and second stream queues 110 and 120. In the classifier 130, the grade of length quantification of the head packet is the nearest grade length longer than itself. The length longer than the length of the highest grade is classified as the highest grade length. The data streams in the queue are represented as F₁, F₂, . . . , and Fₜₐᵢₗ. The packets in the data stream Fᵢ are represented as Pᵢ₁, Pᵢ₂, . . . , and Pᵢₜₐᵢₗ.

A first packet of the data stream corresponds to a packet which is processed for the first time of a system or is first processed when the system restarts after it stops for a predetermined amount of time. To verify a new packet, when there is no packet waiting for scheduling in the data stream of the packet, the packet is regarded as a first packet. When there is a packet waiting for scheduling in the data stream of the packet, the packet is called a subsequent packet of the data stream. Since the count of the virtual start service time of the first packet is not coincident with the count of the subsequent packet of the data stream, the first packet of the data stream should be processed separately. Thus, as shown in FIG. 1, the data queue is divided into two parts, that is, the first stream queue 110 and the second stream queue 120. Processing the first packet of the data stream is performed on the first stream queue 110, and processing the subsequent packet of the data stream is performed on the second stream queue 120. Accordingly, the first and second stream queues 110 and 120 need 2×M×N queues altogether. The SEFF selector 140 selects packets from the first and second stream queues 110 and 120 according to a SEFF strategy and transmits the selected packets to a next node for a predetermined amount of time.

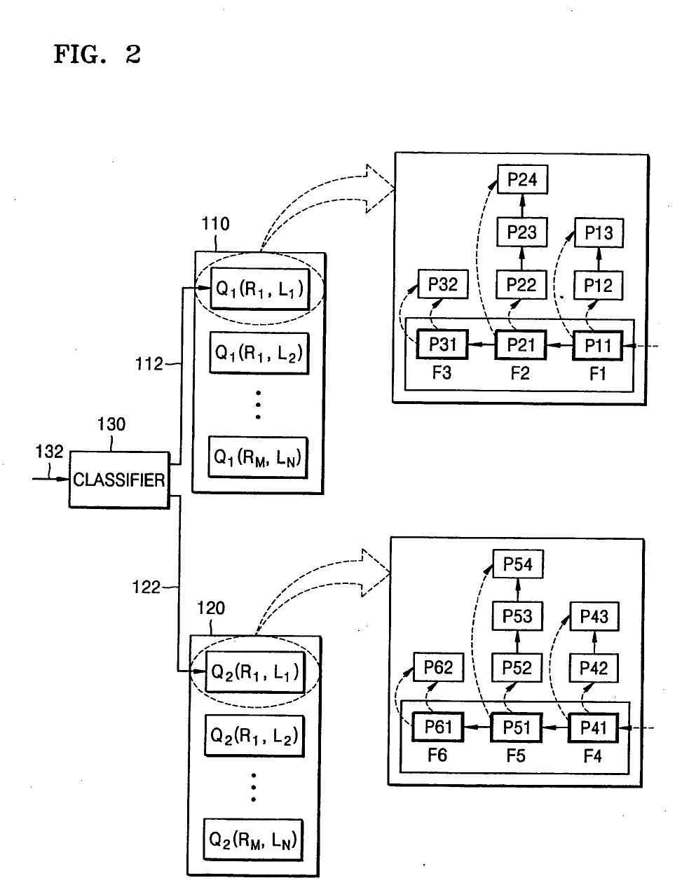

FIG. 2 shows an internal structure of the first and second stream queues 110 and 120.

The classifier 130 determines in which one of the first and second queues 110 and 120 a packet 132 that enters into the scheduler 100 is stored according to a data rate and the length of the packet. In this case, if the packet is a first packet 112, the packet is stored in a predetermined queue Q₁(R₁, L₁) in the first stream queue 110. If the packet is a subsequent packet 122, the packet is stored in a predetermined queue Q₂(R₁, L₁) in the second stream queue 120. The packets 112 and 122 stored in the queues Q₁(R₁, L₁) and Q₂(R₁, L₁) have the same packet length and stream rate.

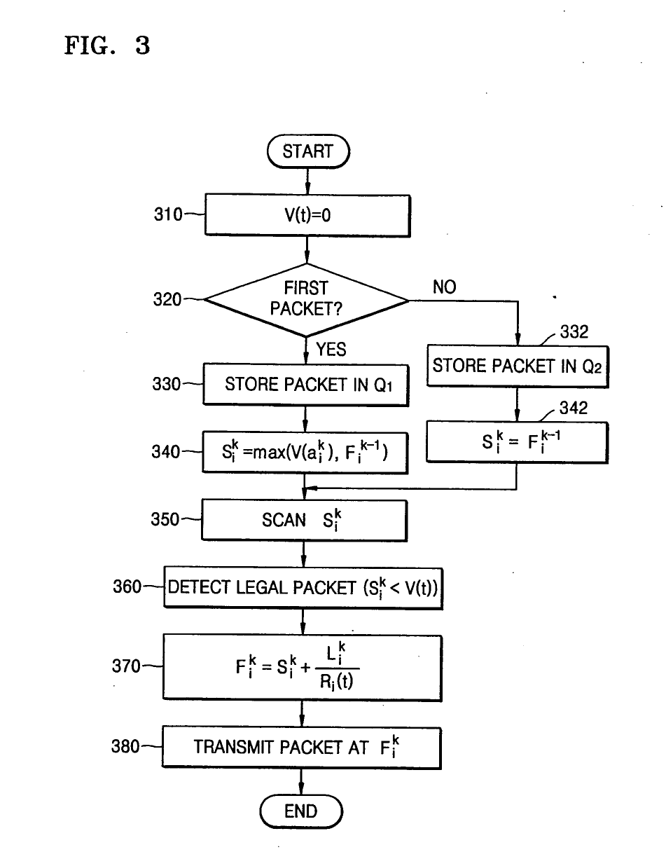

FIG. 3 is a time flowchart showing a packet scheduling method according to an embodiment of the present invention.

In step 310, the scheduler 100 is initialized, and an initial value of a virtual start service time of the scheduler 100 is set to 0, for example.

In step 320, if a predetermined packet reaches the scheduler 100, the classifier 130 checks whether the packet is a first packet of the data stream.

In step 330, if the packet is the first packet, the packet is stored in the first stream queue Q₁(Rₘ, Lₙ) according to the data rate and/or length of the packet.

In step 340, the virtual start service time is counted by Equation 2. The time is a virtual start service time of a corresponding data stream.
Sᵢ^{k}=max(V(aᵢ^{k}),Fᵢ^{k-1})(where Qᵢ=0) (2)

If it is determined in step 320 that the entered packet is not the first packet of the corresponding stream, in step 332, the packet is stored directly in the second stream queue 120, and in step 334, the virtual start service time is counted by Equation 3.
Sᵢ^{k}=Fᵢ^{k-1} (where Qᵢ≠0) (3)

In step 350, the SEFF selector 140 scans a virtual start service time for a head packet of a first stream in all the queues in the first and second stream queues 110 and 120. In this case, all the queues include M×N first stream queues Q₁(R, L) and M×N second stream queues Q₂(R, L).

After that, in step 360, the SEFF selector 140 detects a packet, that is, a legal packet, whose virtual start service time is shorter than a present system virtual time.

In step 370, a virtual finish service time of the legal packet is counted by Equation 4.

$${F}_{i}^{k} = {S}_{i}^{k} + \frac{{L}_{i}^{k}}{{R}_{i} ( t )} \qquad ( 4 )$$

After that, in step 380, the SEFF selector 140 transmits the detected legal packet to a next node at a minimum virtual finish service time. The above-described steps are repeatedly performed until all the packets are transmitted.

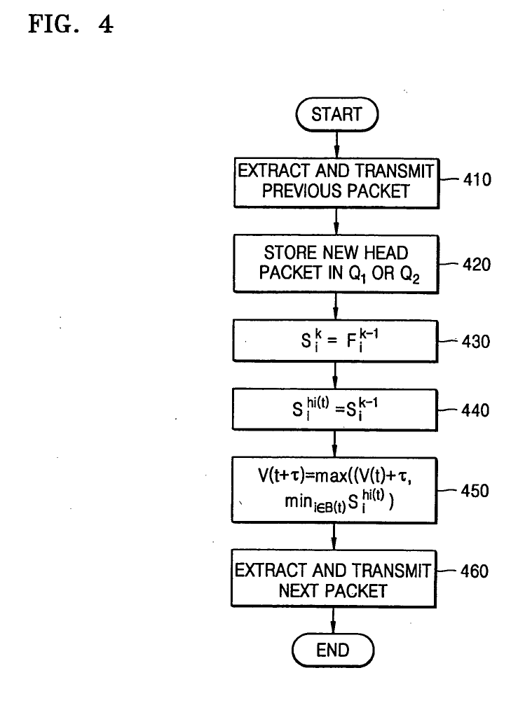

FIG. 4 is a time flowchart showing a system virtual service time is renewed between transmission of a previous packet and transmission of a next packet.

When selecting and transmitting a head packet of a first stream of a first stream queue Q₁(Rₘ, Lₙ) or a second stream queue Q₂(Rₘ, Lₙ), the following procedure is used.

First, in step 410, the SEFF selector 140 extracts a packet from a data stream F and transmits the extracted packet.

Then, in step 420, a new head packet is stored in the first stream queue Q₁(Rₓ, Lₓ) or the second stream queue Q₂(Rₓ, L_{y}) in which the head packet is selected and transmitted. In addition, a next packet of a data stream F is stored in the second stream queue Q₂(Rₓ, L_{y}) according to the data rate and length of the new head packet.

After that, in step 430, the virtual start service time of the data stream F is renewed by Equation 3. The time is also a virtual start service time of a new head packet of the data stream F.

After that, in steps 440 and 450, the system virtual time is renewed by Equation 1.

After that, in step 460, extraction and transmission of the next packet is performed, and then, the above-described steps are repeatedly performed to renew the service time.

In an embodiment of the present invention, a scheduling node used in the packet scheduling method according to the present invention is a router.

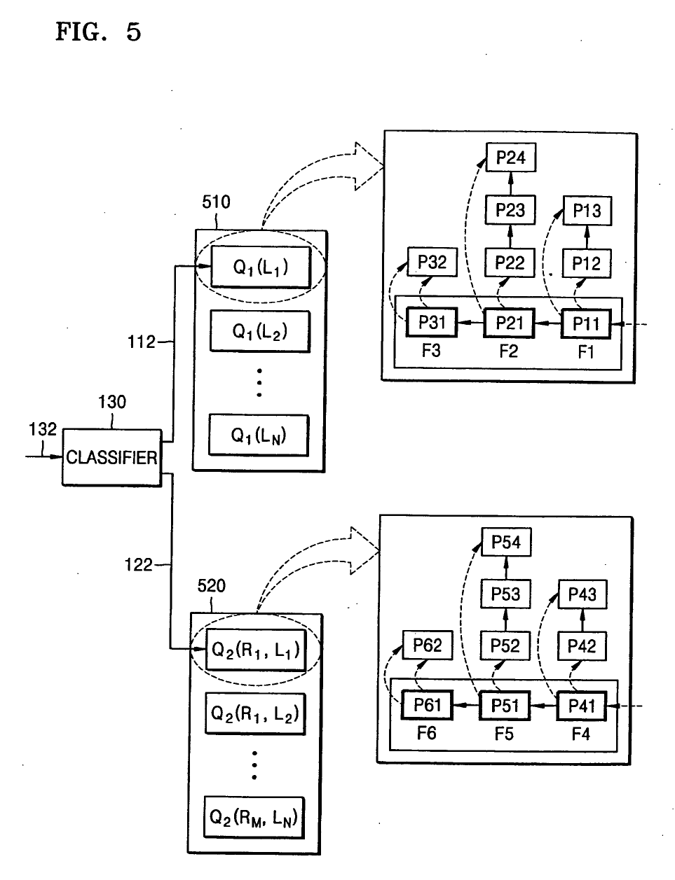

FIG. 5 shows a structure of first and second stream queues according to another embodiment of the present invention.

In FIG. 5, the structure of the second stream queue is the same as that of FIG. 2, but the structure of a first stream queue 510 is different from that of FIG. 2. This is because the structure of the first stream queue is simplified to decrease the quantity of the queues and save hardware resources. Referring to FIG. 5, the first stream queue 510 is classified into either the length of a packet or a data rate and is marked by Q₁(Lₙ) or Q₁(Rₘ). Thus, the queue in the first stream queue 510 needs M×N+N or M×N+M queues.

Hereinafter, a packet scheduling method using queues by length quantification will be described with reference to FIG. 5.

(4) A scheduling node is initialized, and an initial value of a system virtual time is set to 0, for example.

(5) If a predetermined packet reaches the scheduling node, it is checked whether the packet is a first packet of a data stream. If the packet is the first packet of the data stream, the packet is stored at an end of a first stream queue Q₁(Lₙ) corresponding to a data rate of the packet, and a virtual start service time is counted by Equation 2. The time is a virtual start service time of a corresponding data stream. If the packet is not the first packet of the data stream, the packet is directly stored at the end of the corresponding data stream.

(6) In scheduling, a scheduler scans the virtual start service time for a head packet of a first stream in all the queues. In this case, all the queues include N first stream queues Q₁(L) and M×N second stream queues Q₂(R, L). After that, a legal packet whose virtual start service time is shorter than the system virtual time is extracted, and a virtual finish service time of the legal packet is counted by Equation 4. After that, the corresponding packet is transmitted at a minimum virtual finish service time.

(4) When selecting and transmitting a head packet of a first stream of a first stream queue Q₁(Lₙ) or a second stream queue Q₂(Rₘ, Lₙ), the following procedure is commonly used. First, a packet is extracted from a corresponding data stream and transmitted. After that, the packet of the data stream is stored at an end of the second stream queue Q₂(Rₓ, L_{y}) according to the data rate and length of a new head packet. After that, the virtual start service time of the data stream is renewed by Equation 3. This time is also a virtual start service time of a new head packet of the data stream. After that, the system virtual time is renewed by Equation 1.

(6) The above-described procedures (2) through (4) are repeatedly performed until scheduling is terminated.

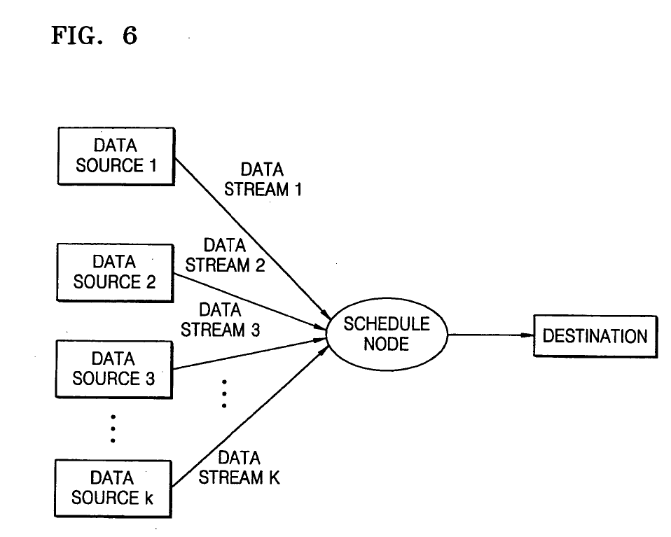

FIG. 6 shows a simulation topological structure according to the present invention.

In FIG. 6, the bandwidth of each input chain is 10 M. All the data streams are scheduled by a scheduling node and are output through an output chain. The rate and length of the scheduling node shown in FIG. 6 are classified into five grades using a simplified method shown in FIG. 5.

Five rate grades for the data stream used in this simulation are as follows:
0.1 Mbps, 0.3 Mbps, 1 Mbps, 2 Mbps, and 5 Mbps.

Five length grades for the data stream used in this simulation are as follows:
200 bytes, 400 bytes, 800 bytes, 1,000 bytes, and 1,600 bytes.

Transmission methods for the data streams used in this simulation are as follows and an On/Off method has been used in this simulation:
constant bit rate (CBR): indicates that the data stream is transmitted at a constant rate.
On/Off: indicates that the data stream is transmitted intermittently.
the same length: the length of the packets in the data stream is the same.
average distribution: the length of the packets in the data stream is evenly distributed within a predetermined range.
normal distribution: the length of the packets in the data stream is normally distributed in a predetermined range based on a predetermined central value.

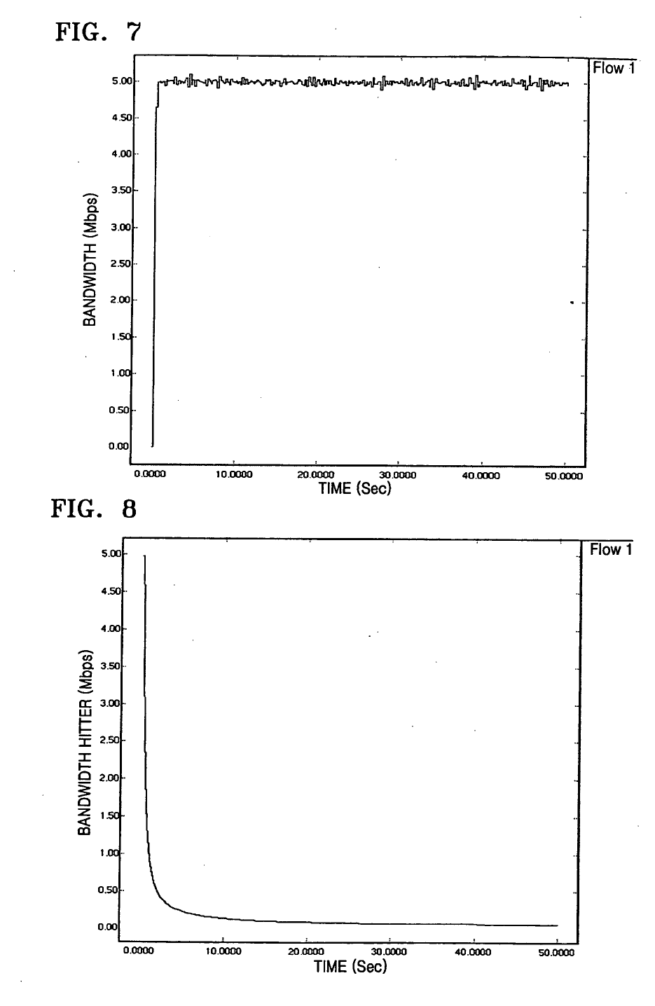

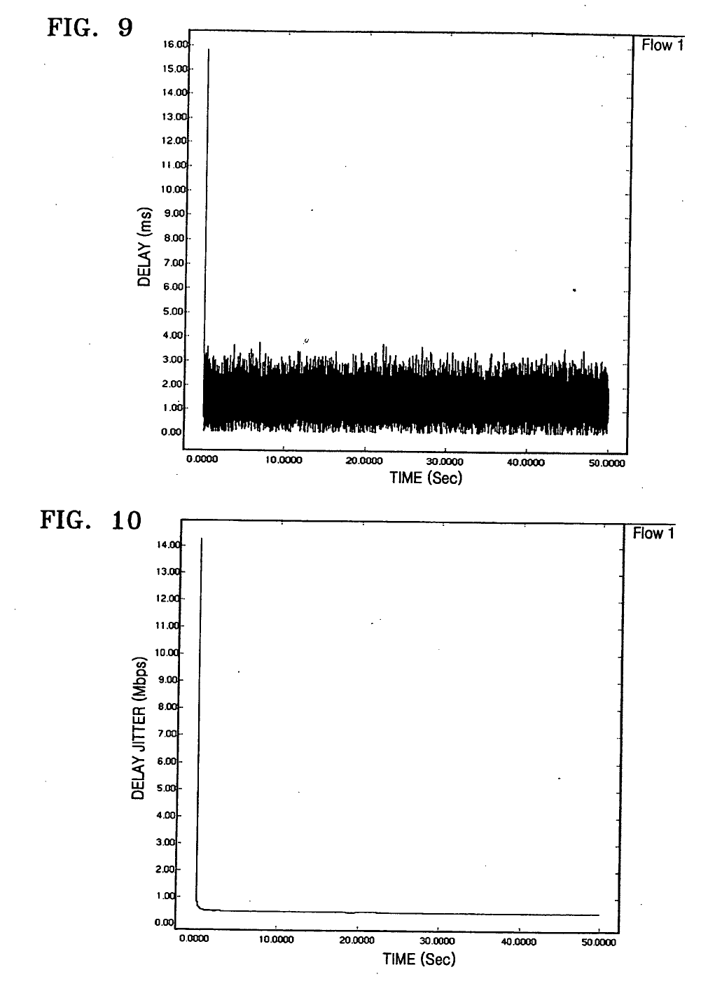

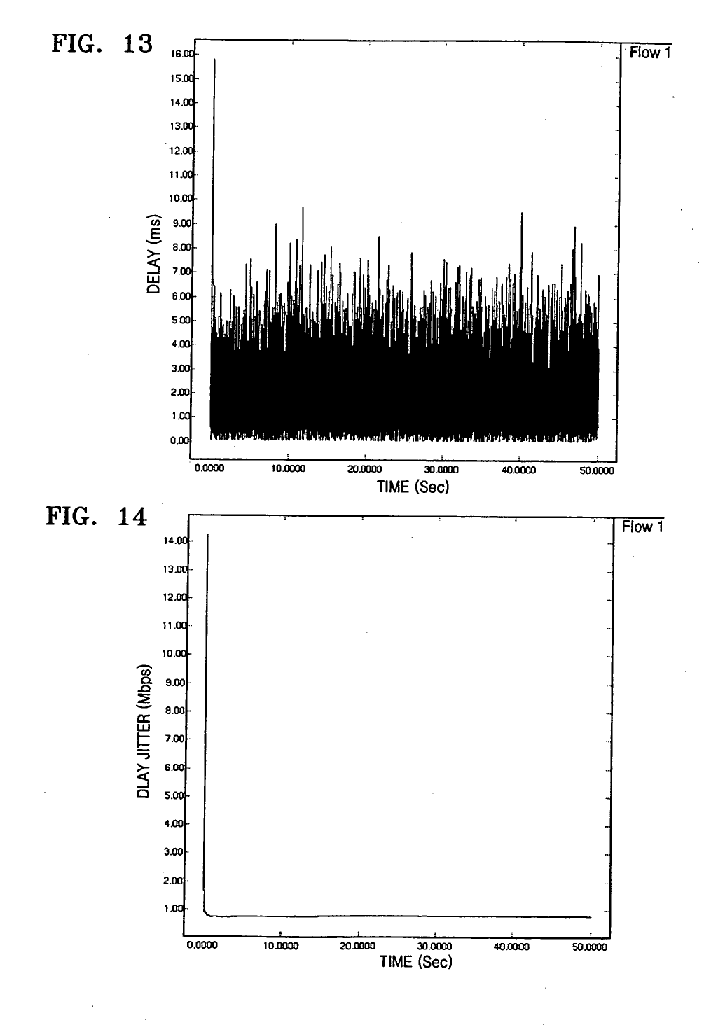

FIGS. 7 through 14 show simulation results of scheduling according to the present invention. To verify the performance of the packet scheduling method according to the present invention, simulation was performed using a network simulator (NS), and the following performance indices were tested.
bandwidth: practical bandwidth Mbps received by each data stream.
bandwidth jitter: average practical difference Mbps of a bandwidth received by each data stream at an adjacent period.
delay: difference, measured in ms, between start and arrival times of the packets of each data stream;
delay jitter: average delay difference between previous packet and subsequent packet of each data stream;

Results refer to part of a detailed performance test method. In general, the method is simple and effective and realizes hardware easily. In addition, the present invention guarantees the performance of a WF²Q⁺ algorithm.

Parameters used in this simulation are shown in Table 2.

TABLE 2

| | | | | Transmission | | |
|---|---|---|---|---|---|---|
| Data Stream | Chain | Performed | | method and | | |
| mark | bandwidth | bandwidth | | rate of data stream | | Length of packets |
| 1 | 10 Mbps | 5.0 Mbps | 50% | On/Off | 5.0 Mbps | Normal distribution |
| 2 | 10 Mbps | 2.0 Mbps | 20% | On/Off | 2.0 Mbps | Normal distribution |
| 3 | 10 Mbps | 1.0 Mbps | 10% | On/Off | 1.0 Mbps | Normal distribution |
| 4 | 10 Mbps | 1.0 Mbps | 10% | On/Off | 1.0 Mbps | Normal distribution |
| 5 | 10 Mbps | 0.3 Mbps | 3% | On/Off | 0.3 Mbps | Normal distribution |
| 6 | 10 Mbps | 0.3 Mbps | 3% | On/Off | 0.3 Mbps | Normal distribution |
| 7 | 10 Mbps | 0.1 Mbps | 1% | On/Off | 0.1 Mbps | Normal distribution |
| 8 | 10 Mbps | 0.1 Mbps | 1% | On/Off | 0.1 Mbps | Normal distribution |
| 9 | 10 Mbps | 0.1 Mbps | 1% | On/Off | 0.1 Mbps | Normal distribution |
| 10 | 10 Mbps | 0.1 Mbps | 1% | On/Off | 0.1 Mbps | Normal distribution |

| | |
|---|---|
| Scheduling | 10 Mbps |
| Output | |

An On/Off model has been used in each data stream of the above configuration. The packet in the data stream uses normal distribution (the average value is 1,000 bits and the deviation is 400 bits). In this test, the performance indices, such as bandwidth, bandwidth jitter, delay, and delay jitter, in the two methods shown in FIGS. 2 and 5 have been measured.

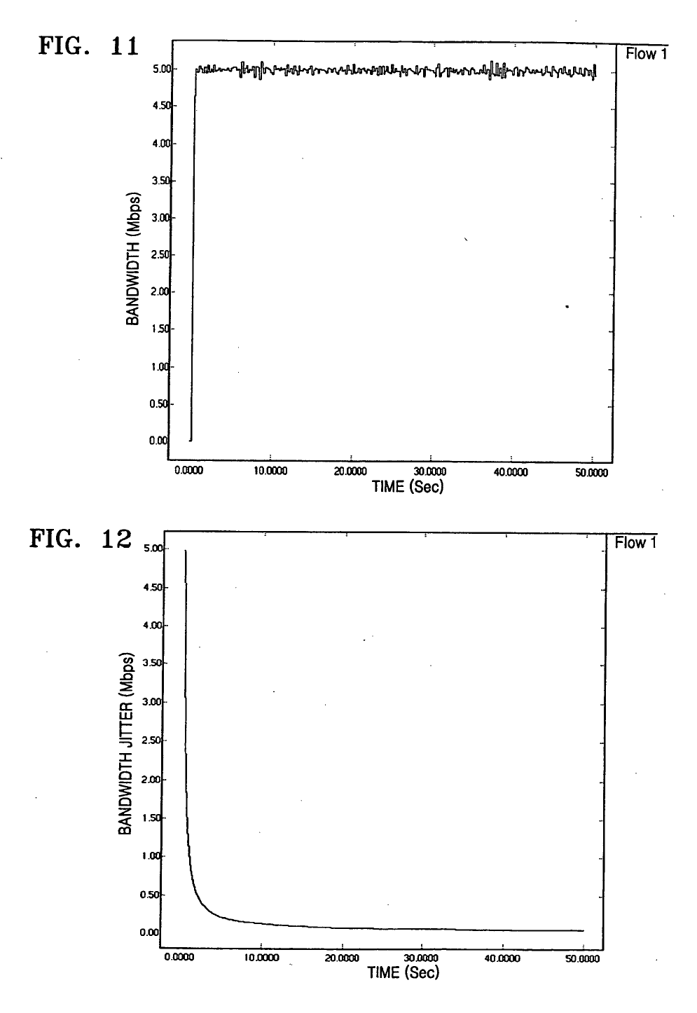

FIGS. 7 through 10 show bandwidth, bandwidth jitter, delay, and delay jitter according to the method shown in FIG. 2. FIGS. 11 through 14 show bandwidth, bandwidth jitter, delay, and delay jitter according to the method shown in FIG. 5.

According to simulation results of FIGS. 7 through 14, the two scheduling methods according to the present invention guarantee the four performance indices. Thus, clients' quality of service (QoS) can be guaranteed.

Based on a simulation performed using a NS, field programmable gate array (FPGA) of Xilinx company has been used to realize scheduling chips. The chips support the maximum of 128 k data streams, five rate grades and five length grades. In addition, the chips can configure a variety of values of all the rates and length grades. According to a practical processing test, the chips can guarantee the performed bandwidth, delay, and fairness of each data stream.

Meanwhile, the packet scheduling method according to the present invention can be written as computer programs. Codes, and code segments of the programs can be easily construed by programmers skilled in the art to which the present invention pertains. In addition, the programs are stored in a computer readable medium, are read and performed by a computer, thereby implementing packet scheduling. Examples of the computer readable recording medium include magnetic storage media, optical recording media, and storage media such as carrier waves.

As described above, according to the present invention, even though the number of data streams is increased, packet scheduling using a simple structure of hardware can be performed.

While this invention has been particularly shown and described with reference to preferred embodiments thereof, it will be understood by those skilled in the art that various changes in form and details may be made therein without departing from the spirit and scope of the invention as defined by the appended claims. The preferred embodiments should be considered in descriptive sense only and not for purposes of limitation. Therefore, the scope of the invention is defined not by the detailed description of the invention but by the appended claims, and all differences within the scope will be construed as being included in the present invention.

1. A packet scheduling method comprising:
(a) classifying a stream according to at least one of a data rate and a length of a packet;
(b) if the packet of the classified stream is a first packet, storing the packet in a first stream queue, and if the packet of the classified stream is a subsequent packet, storing the packet in a second stream queue;
(c) counting a virtual start service time of the packet stored in the first stream queue according to a weighted fairness queuing method; and
(d) counting a virtual start service time of the packet stored in the second stream queue as a virtual start service time of the previous packet.

2. The method of claim 1, wherein step (c) is performed in accordance with a WF²Q or WF²Q⁺ algorithm.

3. The method of claim 2, wherein step (c) is performed in accordance with the following equation:
Sᵢ^{k}=max(V(aᵢ^{k}),Fᵢ^{k-1})(where Qᵢ=0),
where Sᵢ^{k} is a virtual start service time of a k-th packet of an i-th stream, V(t) is a system virtual time function, aᵢ^{k} is an arrival time of the k-th packet of the i-th stream, Fᵢ^{k-1} is a virtual finish service time of a (k−1)-th packet of the i-th stream, and Qᵢ is the quantity of the previous packet contained in a corresponding queue of the i-th stream.

4. The method of claim 1, wherein step (d) is performed according to a smallest eligible virtual finish time first (SEFF) strategy.

5. The method of claim 1, further comprising (e) detecting a legal packet whose virtual start service time is shorter than a system virtual service time by scanning the virtual start service time of the packets stored in the first stream queue and the second stream queue.

6. The method of claim 5, wherein step (e) comprises (e1) counting a virtual finish service time of the legal packet in accordance with the following equation:
$${F}_{i}^{k} = {S}_{i}^{k} + \frac{{L}_{i}^{k}}{{R}_{i} ( t )} ,$$
where Fᵢ^{k} is a virtual finish service time of a k-th packet of an i-th stream, Sᵢ^{k} is a virtual start service time of the k-th packet of the i-th stream, Lᵢ^{k} is the length of the k-th packet of the i-th stream, and Rᵢ(t) is a rate of the i-th stream.

7. The method of claim 5, further comprising (f) transmitting the detected legal packet to a next node.

8. The method of claim 1, wherein the first stream queue of step (b) is classified according to a data rate of the stream.

9. The method of claim 1, wherein the first stream queue of step (b) is classified according to a length of the packet of the stream.

10. The method of claim 1, wherein the first stream queue of step (b) is classified according to a data rate of the stream and a length of the packet.

11. A packet scheduling apparatus comprising:
a classifier, operable to classify a stream according to at least one of a data rate and a length of a packet;
a first stream queue in which a first packet of the classified stream is stored;
a second stream queue in which a subsequent packet of the classified stream is stored; and
a SEFF selector, operable to detect a legal packet from all the packets stored in the first stream queue and the second stream queue according to a SEFF strategy.

12. The apparatus of claim 11, wherein the SEFF selector is operable to count a virtual start service time of the packet stored in the first stream queue according to a weighted fairness queuing method, and further operable to count a virtual start service time of the packet stored in the second stream queue as a virtual start service time of the previous packet.

13. The apparatus of claim 12, wherein a virtual time function of the scheduler is given by:
V(t+τ)=max(V(t)+τ, min_{iεB(t)}Sᵢ^{hi(t)}),
where V(t) is a virtual time function of the scheduler, τ is a time-interval of system virtual time renewal, B(t) is the assembly of all the streams to be backlogged in the scheduler, hi(t) is a serial number of a head packet of a data stream i, and Sᵢ^{k} is a virtual start service time of a k-th packet.

14. The apparatus of claim 12, wherein the SEFF selector is operable to count a virtual start service time of the first stream according to the following equation:
Sᵢ^{k}=max(V(aᵢ^{k}), Fᵢ^{k-1})(where Qᵢ=0),
where Sᵢ^{k} is a virtual start service time of a k-th packet of an i-th stream, V(t) is a system virtual time function, aᵢ^{k} is an arrival time of the k-th packet of the i-th stream, Fᵢ^{k-1} is a virtual finish service time of a (k−1)-th packet of the i-th stream, and Qᵢ is the quantity of the previous packet contained in a corresponding queue of the i-th stream.

15. The apparatus of claim 12, wherein the SEFF selector is operable to count a virtual start service time of the second stream queue according to the following equation:
Sᵢ^{k}=Fᵢ^{k-1} (where Qᵢ≠0),
where Sᵢ^{k} is a virtual start service time of a k-th packet of an i-th stream, Fᵢ^{k-1} is a virtual finish service time of a (k−1)-th packet of the i-th stream, and Qᵢ is the quantity of the previous packet contained in a corresponding queue of the i-th stream.

16. The apparatus of claim 12, wherein the SEFF selector is operable to scan the virtual start service time of the packets stored in the first stream queue and the second stream queue and detect a legal packet whose virtual start service time is shorter than a system virtual service time.

17. The apparatus of claim 16, wherein the SEFF selector is operable to count a virtual finish service time of the legal packet in accordance with the following equation:
$${F}_{i}^{k} = {S}_{i}^{k} + \frac{{L}_{i}^{k}}{{R}_{i} ( t )} ,$$
where Fᵢ^{k-1} is a virtual finish service time of a k-th packet of an i-th stream, Sᵢ^{k} is a virtual start service time of the k-th packet of the i-th stream, Lᵢ^{k} is the length of the k-th packet of the i-th stream, and Rᵢ(t) is a rate of the i-th stream.

18. The apparatus of claim 11, wherein the first stream queue is classified according to a data rate of the stream.

19. The apparatus of claim 11, wherein the first stream queue is classified according to a length of the packet of the stream.

20. The apparatus of claim 11, wherein the first stream queue is classified according to a rate of the stream and a length of the packet.
